(19) United States
(12) Patent Application Publication
(10) Pub. No.: US 2004/0141017 A1
(43) Pub. Date: Jul. 22, 2004

(54) Twice click method for processing data

(75) Inventors: Lien-Chun Ding, Taoyuan (TW); Ching-Kang Lee, Taipei (TW)

Correspondence Address: BEVER HOFFMAN & HARMS, LLP, TRI-VALLEY OFFICE, 1432 CONCANNON BLVD., BLDG. G, LIVERMORE, CA, 94550, US

(73) Assignee: EC-Server.com., INC

(21) Appl. No.: 10/406,335

(22) Filed: Apr. 2, 2003

(30) Foreign Application Priority Data
Jan. 17, 2003 (TW) 092101053

(51) Int. Cl. G09G 5/00

(52) U.S. Cl. 345/860

(57) ABSTRACT

A twice click method for processing a data in a web page is provided. The method includes steps of providing a function menu and an operating button group, clicking the function menu and inputting an index for the data, selecting an executing button from the operating button group, and clicking the executing button to execute a specific operation for the data.

### FIELD OF THE INVENTION

This invention relates to a twice click method for processing a data, and more particularly to a twice click method for processing an object data in one web page.

### BACKGROUND OF THE INVENTION

Nowadays, the development and the popularization of internet are both extremely fast. The internet almost becomes the most important tool in our life. And, for the ISP (Internet Services Provider) the key point for more users is to make the operation interface “easy to use”. However, generally the operation interface always needs to fill a data in a form tediously, click continuously, and switch the pages constantly in the traditional application. In this situation, because of the complicated steps, the user has to take a lot of time and feels inconvenient extremely. Therefore, the present invention breaks through the traditional way and brings up a concept of “twice click”. The technology of “twice clicks” may simply the operation and reduce the steps so as to economize the time and improve the efficiency. Consequently, the “twice click” can help the enterprise to become an e-enterprise quickly.

Please refer to Table 1. Table 1 shows the comparison of the traditional program design and the novel 2 clicks concept.

TABLE 1

| | Traditional program | |
|---|---|---|
| Items | design | twice click concept |
| Operation steps | Complicated. And it may | Simple. And it needs |
| | need several pages. | only one page. |
| Easy or not | It needs more time to learn | All the content can be |
| | the complicated operation. | easily understand. |
| Operation time | Longer | Short |
| Is it easy to | It is easy to cause a mistake | It is not easy to make a |
| make a mistake? | because of the complicated | mistake because of the |
| | operation. | easy operation. |
| Displaying mode | Different programs adopt | All the programs adopt |
| | different displaying modes | the same design. |
| | and the user has to learn | |
| | many times. | |

Because of the technical defects described above, the applicant keeps on carving unflaggingly to develop a “twice click method for processing data” through wholehearted experience and research.

### SUMMARY OF THE INVENTION

It is an object of the present invention to provide a twice click method for processing an object data in only one web page.

It is another object of the present invention to provide a twice click method which can simplify the operating steps and also reduce the operation time when processing the object data.

According to an aspect of the present invention, a twice click method for processing a data in a web page includes steps of providing a function menu and an operating button group, clicking the function menu and inputting an index for the data, selecting an executing button from the operating button group, and clicking the executing button to execute a specific operation for the data.

Preferably, the data is an object data.

Preferably, the object data is stored in a network database.

Preferably, the operating button group comprises an Append button, a Query button, an Amend button and a Delete button.

Preferably, the executing button is one selected from a group consisting of the Append button, the Query button, the Amend button and the Delete button.

In accordance with another aspect of the present invention, a twice click method for processing a data in a web page is provided. The web page includes a function menu and an operating button group, an index of the data is inputted by means of clicking the function menu, and a specific operation is executed for the data by means of clicking an executing button of the operating button group.

Preferably, the data is an object data.

Preferably, the object data is stored in a network database.

Preferably, the operating button group comprises an Append button, a Query button, an Amend button and a Delete button.

Preferably, the executing button is one selected from a group consisting of the Append button, the Query button, the Amend button and the Delete button.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 shows the page of a back office in a preferred embodiment according to the present invention; and

FIGS. 2˜4 show the building pages of a first-grade product classification of the back office in a preferred embodiment according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

The technology of twice click in the present invention own powerful and flexible design and is also an object-oriented design so that the user only needs to click the selected button and follows the four steps: appending, querying, amending and deleting, and then the ideal operation may be completed. The twice click own the simplest operation interface, and the operation can be completed only in twice clicks. Take an electronic catalogue as an example for further explaining the easy operation. Except key in, all the operation steps may be finished in twice click.

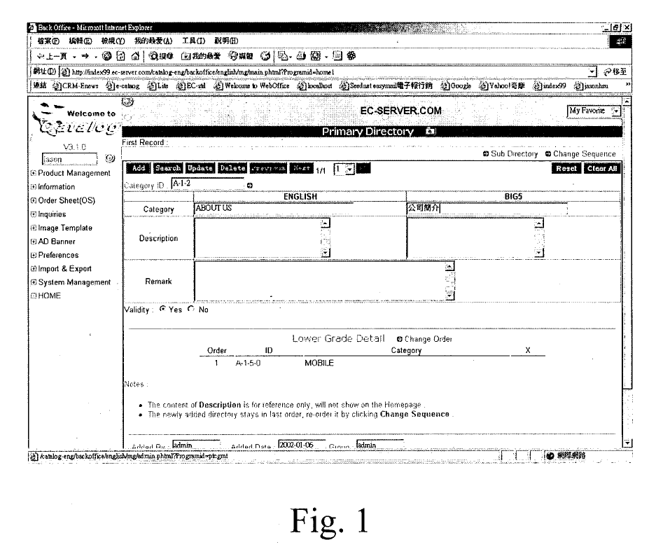

Please refer to FIG. 1 which illustrates the page of the back office page in a preferred embodiment according to the present invention. The title is “first-grade product classification”. The operation steps are described as follows.

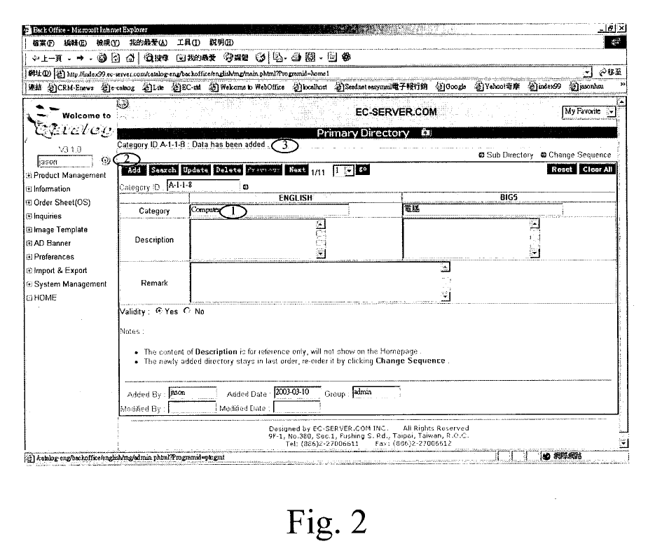

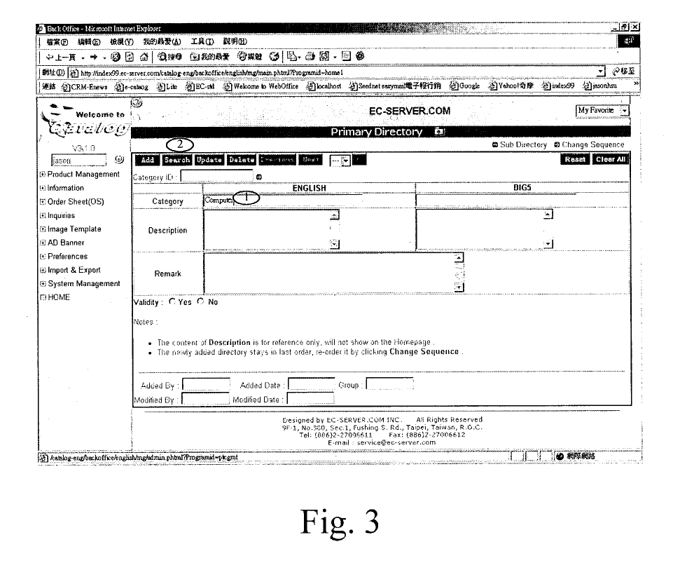

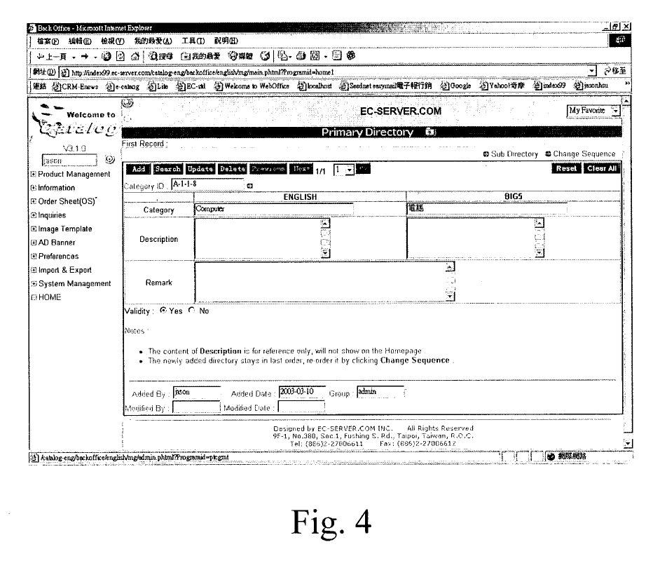

(1) After entering the page for building the first-grade product classification of the back office, as shown in FIG. 2,

1. The first click: click the function menu and input an index for the product classification (shown as label \mathring{1});

2. The second click: click the “Append” button (shown as label \mathring{2}); and

3. The user will see that the data has been newly added in the product classification at this page (shown as label \mathring{3}).

(2) When querying the built data in the product classification, as shown in FIG. 3,

1. The first click: click the function menu and input the data range which is needed to be queried (shown as label \mathring{1}) (an index can be inputted into all the columns in this page, for example, if the user wants to query a data including “computer”, “computer” can be inputted into the column of “classification title”);

2. The second click: click the “Append” button in the function button group (shown as label \mathring{2}); and

3. At this time, the result has been shown in the same page. All the operations may be completed in one page and don't need to switch the web pages. Twice click can complete all the operations.

(3) The operation processes of amending and deleting data are similar and the web pages don't need to be switched so that all the operations can be completed in the same page. The only difference is to select different executing button of the operating button group, as shown in FIG. 4.

If the user wants to amend a data, it only needs to input the content which is wanted to be amended and after clicking the Amend button of the operating button group, the operation can be completed. If the user wants to delete a data, it only needs to click the Delete button of the operating button group and after clicking the Yes button in the querying window for confirming the deletion, the deletion can be completed.

In view of the aforesaid, all operation steps in present invention are appending the data, querying the built database, amending the data, deleting the data, and producing a form of the data. However, the present invention reduces the operation as: clicking the first click, inputting the data, and clicking the second click on one button of the operating button group. Therefore, this design can efficiently simplify the operating procedures and increase the speed for processing the data. Consequently, the present invention is creative, novel and progressive. Furthermore, the present invention not only conforms to the demand of the industry but solve the defects in the prior art, so that it's industrial valuable.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A twice click method for processing a data in a web page, comprising steps of:
(a) providing a function menu and an operating button group;
(b) clicking said function menu and inputting an index for said data;
(c) selecting an executing button from said operating button group; and
(d) clicking said executing button to execute a specific operation for said data.

2. The method according to claim 1, wherein said data is an object data.

3. The method according to claim 2, wherein said object data is stored in a network database.

4. The method according to claim 1, wherein said operating button group comprises an Append button, a Query button, an Amend button and a Delete button.

5. The method according to claim 4, wherein said executing button is one selected from a group consisting of said Append button, said Query button, said Amend button and said Delete button.

6. A twice click method for processing a data in a web page, wherein said web page comprises a function menu and an operating button group, an index of said data is inputted by means of clicking said function menu, and a specific operation is executed for said data by means of clicking an executing button of said operating button group.

7. The method according to claim 6, wherein said data is an object data.

8. The method according to claim 7, wherein said object data is stored in a network database.

9. The method according to claim 1, wherein said operating button group comprises an Append button, a Query button, an Amend button and a Delete button.

10. The method according to claim 9, wherein said executing button is one selected from a group consisting of said Append button, said Query button, said Amend button and said Delete button.
